(19) United States
(12) Patent Application Publication
(10) Pub. No.: US 2015/0101065 A1
(43) Pub. Date: Apr. 9, 2015

(54) USER CONTROLLED DATA SHARING PLATFORM

(71) Applicant: BIO-key International, Inc., Eagan, MN (US)

(72) Inventor: James D. Sullivan, Milton, GA (US)

(73) Assignee: BIO-Key International, Inc.

(21) Appl. No.: 14/505,697

(22) Filed: Oct. 3, 2014

Related U.S. Application Data
(60) Provisional application No. 61/886,832, filed on Oct. 4, 2013.

(51) Int. Cl. G06F 21/62

(52) U.S. Cl. CPC G06F 21/6245; G06F 21/6218; G06F 21/6263
USPC 726/28

(57) ABSTRACT

A method of controlling access to stored data is provided. In one embodiment, a method of controlling access to stored data comprises receiving a request from a recipient to access to the stored data, where the stored data is associated with an individual. The method may also comprise notifying the individual of the request to access the stored data. The method may also comprise requesting authorization for the recipient to access the stored data. The method may also comprise receiving a response from the individual regarding authorization to access the stored data and, upon a determination that authorization is granted, allowing the recipient access to the stored data. In one embodiment the method is configured to be implemented on a computing device with a processor.

### CROSS REFERENCE TO RELATED APPLICATION

The present claims the priority of provisional application Ser. No. 61/886,832, filed on Oct. 4, 2013, the content of which is hereby incorporated by reference in its entirety.

### INCORPORATION BY REFERENCE

U.S. Pat. No. 7,117,356, issued Oct. 3, 2006 is herein incorporated by reference in its entirety.

### BACKGROUND

Maintaining privacy regarding personal information is one of the most concerning aspects of our Internet connected lives today, and there is a constant debate over the benefits and risks of allowing enterprises and service providers to accumulate personal information because of the high possibility of misuse of such information, which, once collected, is difficult to retrieve.

Medical records are one example of the kind of data that offers benefits from being stored and available in the cloud. An example of the benefit of cloud storage of medical records is that a patient can enter a medical center and give the medical center access to their medical history to provide comprehensive treatment. However, storing information in the cloud raises the risk this data could be misappropriated or used for unintended purposes, for example the data may be compromised by a hacker, by a accessed by a non-authorized staff member, or by an insurer or employer that may want to access such information before making a commitment to a potential customer or employee. The fear of misuse or loss of control of the data causes many individuals (the source of such data) to refrain from sharing their personal information and the fear of liability of from regulatory violation or misuse of the information leads enterprises (the recipient of such data) to refrain from storing them.

Similarly, there is a great deal of recent focus on the risks and benefits of having biometric data including, but not limited to, raw fingerprints, iris, facial, voice, vein pattern, or mathematically derived extracts or templates created from any of these by biometric vendor algorithms to match candidates against them for authentication or identification purposes. In response, many regulations and laws are in place to protect individual rights to control personal data. After collection many regulations dictate procedures that must be followed relating to the retention and deletion of the collected biometric data, including the rights of individuals from whom biometric data is collected to request its deletion from storage at any time. Many individuals and enterprises are hesitant to engage in biometric activities that would benefit from the value of centralized record storage of personal information because of the security and regulatory risks.

Mobile biometric authentication presents many complex technical challenges: using servers allows for important capabilities of in person identification without any device, auditing and logging for non-repudiation, consistent authentication across many devices without re-enrolling, and duplicate record detection. On-device matching allows local applications to authenticate without a network, as well as allowing users to keep their biometric data on their device. Customers want to incorporate those on-device authentication modules into an overall fingerprint biometric ecosystem which spans mobile, laptop, as well as face-to-face authentication scenarios for convenient, but safe password recognition across platforms.

An important feature missing for current users is the option to have complete control over their personal data—where it is stored, in what form it is stored, and which applications and recipients may access it. Within a typical security system, biometric or otherwise, there are at least two operations, enrollment and authentication. The enrollment operation encompasses the original sampling of the person's biometric or other information, and the creation and storage of a matched template (a.k.a., an enrollment template) that is a data representation of the original sampling. The authentication operation includes an invocation of a portion of information, for example biometric information, for the identification or verification of the system user through comparison of the information provided with the stored information.

### SUMMARY

A method of controlling access to stored data is provided. In one embodiment, a method of controlling access to stored data comprises receiving a request from a recipient to access to the stored data, where the stored data is associated with an individual. The method may also comprise notifying the individual of the request to access the stored data. The method may also comprise requesting authorization for the recipient to access the stored data. The method may also comprise receiving a response from the individual regarding authorization to access the stored data and, upon a determination that authorization is granted, allowing the recipient access to the stored data. In one embodiment the method is configured to be implemented on a computing device with a processor. These and various other features and advantages that characterize the claimed embodiments will become apparent upon reading the following detailed description and upon reviewing the associated drawings.

### BRIEF DESCRIPTION OF THE DRAWINGS

FIG. 1 is a depiction of information belonging to an individual interacting with a plurality of entities in accordance with one embodiment.

FIG. 2 is a view of a plurality of entities accessing a data record of an individual in accordance with one embodiment.

FIG. 3 is a flow diagram of an exemplary method of creating and updating a data record in accordance with one embodiment.

FIG. 4 is a flow diagram of an exemplary method of requesting and obtaining information from a data record in accordance with one embodiment.

FIG. 5 is a diagrammatic view of a recipient-stored data record and individual-stored key in a network environment in accordance with one embodiment.

FIG. 6 is a diagrammatic view of a recipient and an individual interacting in a network environment in accordance with one embodiment.

FIG. 7 is a flow diagram of a method of creating, encrypting, and storing information in a data record in accordance with one embodiment.

FIG. 8 is a flow diagram of a method of requesting a key for a data record in accordance with one embodiment.

FIGS. 9A and 9B illustrate exemplary notifications delivered through a user-interface in accordance with one embodiment.

FIGS. 10A-D illustrate an exemplary process of changing settings for data access to a data record in accordance with one embodiment.

FIG. 11 illustrates an exemplary home screen of a user-interface in accordance with one embodiment.

FIG. 12 illustrates an exemplary data record accessible on a user-interface in accordance with one embodiment.

FIG. 13 illustrates an exemplary access history of a data record on a user-interface in accordance with one embodiment.

### DETAILED DESCRIPTION OF ILLUSTRATIVE EMBODIMENTS

Embodiments described below facilitate complete control by an individual over their own information. This control includes where the information is stored, in what form, and what applications can access the information. Specifically, an individual can, in one embodiment, save their information in a data record, stored either by the individual or a third party. The individual can segment the information stored in the data record, such that different applications are limited to accessing different portions of the information.

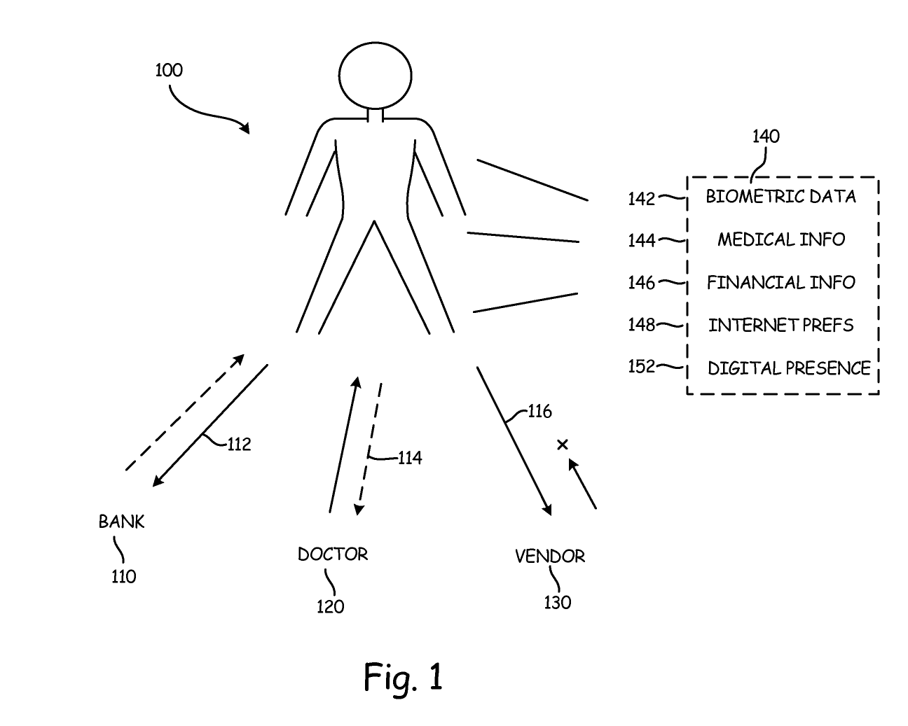

This control also serves to assist applications and/or corporations in complying with regulations concerning data privacy. Applications may, in one embodiment, allow users to limit access by the application to their information—even when such information is stored on a server in a public or private environment accessible to the application. This provides users with complete control of how their information is accessed, when their information is accessed, and what information is accessible by whom. Both the underlying application and individual 100 (shown in FIG. 1) are aware of when, how and where any authentication is taking place, allowing applications to apply risk-aware policies based on the nature and security of any match performed. Providing users this control will enable the applications and/or corporations to more easily comply with the variety of privacy laws affecting retention of biometric data, healthcare information and other sensitive data files, without the overhead of having to manually manage compliance for their users. Because individual 100 is in charge of their own information, informed consent for continued retention and compliance with removal requests is or can be implicit.

### Data Record Creation and Maintenance

FIG. 1 is a depiction of information belonging to an individual 100 interacting with a plurality of entities according to one embodiment. Individual 100 may interact with a variety of entities, for example bank 110, doctor 120, and/or vendor 130. These interactions may take place in person or over a network, and may require a transfer of information. For example, doctor 120 may require a vaccination history. A current problem faced by individuals is a way to access and store their own information in a secure manner such that they can facilitate sharing that information with necessary entities. In the vaccination history example, a user may not have access to their vaccination history in a format that allows for easy delivery to doctor 120. Individual 100 may need to physically visit or call another physician office in order to get their vaccination history shared with doctor 120. Individual 100 may also need to sign a release in order to obtain a physical copy of the vaccination history in order to give it to doctor 120. Instead, individual 100 may, in one embodiment, obtain a copy of their entire medical history from their former physician, store it in a data record 140, and easily authorize access to either their entire medical history, or in another embodiment, only their vaccination history, to doctor 120.

In another example, individual 100 may be shopping online and be prompted to enter credit card information in order to complete a transaction with vendor 130. Individual 100 may further want to complete the transaction without the vendor having access to their credit card information. In one embodiment, individual 100 may want to have their credit card information protected such that vendor 130 does not have direct access to their credit card number and expiration information.

In one embodiment, individual 100 may be granting access to any of these entities to all or a part of their data record 140. As shown, the individual 100 may interact with these entities in a variety of ways. For example, in one embodiment as shown by interaction 112, bank 110 responds to a request from the individual 100, as illustrated by the solid arrow, and returns the requested information, as shown by the dotted arrow of 112. In another embodiment, the individual 100 may receive a request, as shown in communication 114 by the solid line, from a doctor 120 requesting information, for example the vaccination history described above. In another embodiment, individual 100 may interact with a vendor 130, but prevent the vendor from requesting and/or obtaining information from the individual at a later date, for example as shown in communication 116. Additionally, individual 100 may interact with vendor 130 in such a way that vendor 130 does not have further access to their credit card information. This may, for example, provide peace of mind to individual 100 in the event that the vendor 130 has a data breach of stored credit card information.

Individual 100 may choose to grant access to part of their data record to any of these, or other, enterprises. The data record 140 may include, in one embodiment, biometric data 142, medical information 144, financial information 146, Internet preferences 148, and a digital presence 152. However, in another embodiment, the data record 140 may include any combination of data specified by individual 100. For example, individual 100 may choose to store information pertaining to a single credit card in a data record 140. Additionally, individual 100 may be associated with a plurality of data records 140, for example a first data record 140 storing credit card information for a single credit card, and a second data record 140 storing medical records, a third data record 140 storing pictures and a fourth data record 140 storing other information. Further, each of these data records 140 may be partitioned into a plurality of portions such that access to a data record 140 can be granted for only a portion of the data in the data record 140 such that, for example a recipient can have access to the medical records without seeing the pictures, or vice versa.

Further, in the embodiment where an individual 100 wants to allow the vendor to keep their credit card information for future transactions, the individual 100 may allow the vendor to store a data record 140 such that the vendor 130 has, but cannot access without permission (and a key from the individual) the credit card information.

In one embodiment, the data of the individual's data record 140 can be generated either by the individual 100, or any one of the enterprises. For example, the doctor 120 may provide the individual 100 with updated medical information 144, for example the results of a test run by the doctor 120. In another embodiment, individual 100 may send information, for example their financial information 146, to a bank 110 in order to have services provided. In another embodiment, individual 100 may choose to limit some or all access to data in the data record 140 to a specific entity, for example individual 100 may choose to only give some of their biometric data 142, for example a name, an address, and an e-mail address, to a vendor 130 in order to elicit further information. However, individual 100 may choose to not give vendor 130 access to all of their biometric data for example, fingerprint, handprint, iris, or other biometric information. In one embodiment, individual 100 may also use the data record 140 to store their Internet preferences 148. Internet preferences 148 may comprise a series of passwords for different sites as well as a series of usernames associated with those passwords.

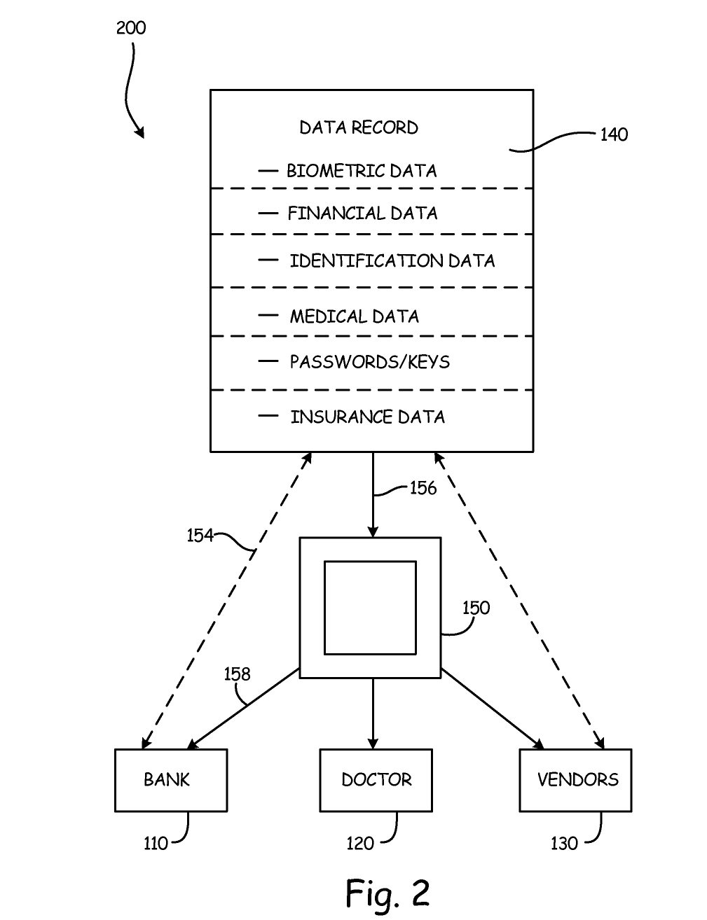

FIG. 2 is a view of a plurality of entities accessing a data record of an individual in accordance with one embodiment. In one embodiment, individual 100 interacts with the data record 140 and any one of a plurality of enterprises through device 150. The device 150 may be a mobile phone, a tablet, a personal computer, or any other appropriate device. The device 150 provides both access to the data record 140 by the individual 100. In another embodiment, the device 150 provides a platform, for example in the form of an application on the device 150, to allow access to the data record 140 by any of the different entities.

For example, a request may be generated by a bank 110, as shown by request 154, to access the data record 140. In one embodiment, upon receiving such a request, the storage provider of the data record 140 sends an authentication request to individual 100's device 150, as shown by request arrow 156. In one embodiment, individual 100 then has the opportunity to see that a request has been sent, for example in real time via text message, e-mail or other appropriate communication means. Individual 100 then has the option to approve or deny that request for information. For example, in one embodiment, the individual 100 may have earlier gone to a bank 110 and started a mortgage application. However, after the individual started the process, the bank 110 needed information that the individual 100 did not have on hand. The bank 110 then could send a request to the storage provider of the data record 140, in one embodiment while individual 100 is still at the bank 110, and individual 100 can then approve release of that information to the bank 110 through the device 150. This allows for the bank 110 to receive that information in substantially real time.

However, in another embodiment, the bank 110 may realize that more information is needed after an individual 100 has left the premises. In that embodiment, the bank 110 can also send a request 154 to access the data record 140 and receive authorization even though the individual 100 is not on the bank premise. In another embodiment, the bank 110 may already have pre-authorized access to access information to the data record 140. For example, this pre-authorization may have been set up by the individual 100 when the bank 110 was initially asking for mortgage information, in the example described above. In such an embodiment where a pre-authorization has been given, the bank 110 sends a request 154 to the data record storage provider which a sends a notification 156 to client device 150 indicating that pre-authorization has been given and then the information is then transmitted to the bank 110 as shown by arrow 158. Similarly, this process could also occur for any other entity, for example doctor 120 or vendor 130.

In a further embodiment, bank 110 may not want access to the entirety of data record 140, or individual 100 may not want to give access to data record 140. However, bank 110 may need to answer a question; for example whether individual 100 is older than 25. In one embodiment, a functional module is provided by the holder of the data record 140 that receives the question from the bank 110, compares it to the information in the data record 140, and returns an answer to the bank 110, all without granting the bank 110 access to the information in the data record 140. For example, the data record 140 may contain a birth date of the individual 100 that the functional module can compare to a current date to determine that individual 100 is 32 years old. The functional module can then return a “yes” to the bank 110, without providing the bank 110 with the birth date or exact age of individual 100. In a similar example, doctor 120 may need to treat individual 100 and need to know whether individual 100 has allergies to a specific antibiotic. The doctor 120 may be able, in one embodiment, query the data record 140 to determine whether individual 100 has an allergy to penicillin and receive a yes/no answer without obtaining access to the data files in the data record 140.

In another example, the bank 110 may want to confirm that an individual 100 is who they claim to be. The bank 110 may take a biometric sample from individual 100 and seek whether or not the biometric sample matches a previously taken sample on file in the data record 140. For example, the individual 100 may have previously submitted to their data record 140 a finger print. In order to determine that the individual 100 is who they claim to be, the bank 110 may take a new finger print and submit the print to the data record 140 for confirmation. The holder of the data record 140 may send back either a determination that the print taken by the bank 110 does or does not match a finger print in the data record 140, or they may send back a score indicating a level of match, for example that there is a 99% probability that the individual 100 is who they claim to be.

In one embodiment, the functional module may also incorporate data manipulation functions to allow for provision of required information without access to the data record 140. For example, in one embodiment, the functional module may implement formulaic analysis, data augmentation, as well as comparison between received samples and previously taken samples stored in the data record 140. Further, the module could also be configured to add information to the data record 140 when obtained. For example, the module could add the sample taken by the bank 110 to the data record 140. Additionally, the functional module may allow for an entity, such as the bank 110 to add a data file to the data record 140, for example a current credit score, without ever having access to or seeing the data record 140. These, and other appropriate data manipulation functions may be used in order to provide additional protection from unauthorized access.

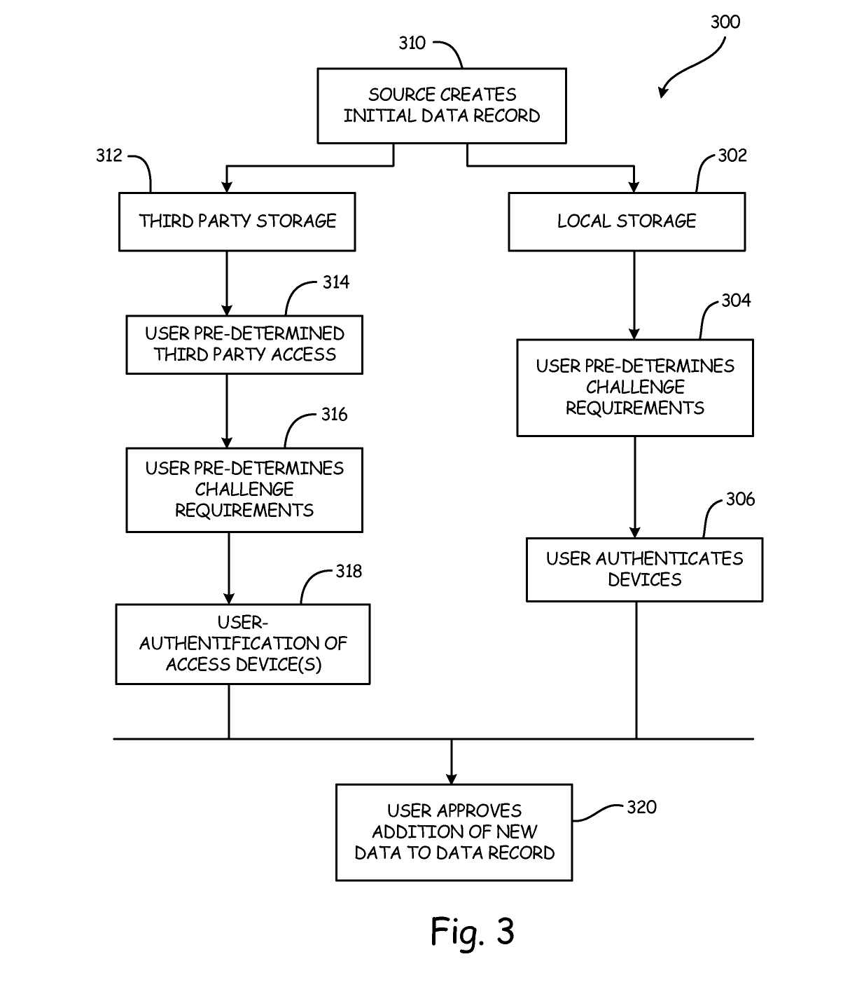

FIG. 3 is a flow diagram of an exemplary method of creating and updating a data record in accordance with one embodiment. As shown in FIG. 3, method 300 allows for two different storage providers of data in the data record 140. The data record 140 may be stored locally by individual 100 or may be stored by a third party. As described in FIG. 3, local storage refers to storage controlled by individual 100 whereas third party storage refers to storage under the control of the third party that is neither the individual 100 nor one of the enterprises seeking the information. In one embodiment, the access key 504 to a data record 140 may be stored by individual 100 such that the entity storing data record 140 does not have access without obtaining the key 504 from individual 100.

Method 300 starts in block 310 by the source of information, for example individual 100, creating the initial data record. This may include individual 100 collecting all of their medical records 144, their financial records 146, their Internet preferences 148, and their digital presence information 152 and biometric data samples 142. In one embodiment, individual 100 then stores this information on a data record in a local storage as shown in 302. This could involve for example scanning and uploading all of individual 100's information that comprises the data record 140 onto the individual's personal computer storage device. In another embodiment, individual 100 may upload their information to local storage as shown in block 302 where local storage comprises cloud storage of all of the information. Individual 100 may also provide some of their biometric information 142, for example fingerprint or handprint, by taking pictures or using other functionality of a device, for example a mobile phone.

Individual 100 then, after storing the information comprising their data record 140, may choose to predetermine challenge requirements in block 304. This step comprises, in one embodiment, individual 100 determining what level of security is required for each of the different types of information in the data record 140. For example, if a recipient is requesting information to individual 100's digital presence information 152, for example access to individual 100's Facebook page, individual 100 may set lower challenge requirements than, for example, a request to access medical information. Individual 100 may also set these challenge requirements based on different entities that may request information. For example, a local clinic or doctor's office that the individual frequents may have a lower challenge requirement to access medical information than a financial institution that individual 100 has never interacted with previously, in one embodiment. Additionally, in one embodiment, the data record 140 is configured such that access is only given to a sub-portion of the data record 140. For example, the local clinic may request access and be granted to a single blood test result. Additionally, as discussed above, the local clinic may be able to query the data record 140, for example to determine whether an individual is HIV positive.

Individual 100 may then authenticate the devices that are able to approve or deny requests in block 306. For example, individual 100 may approve their cell phone for accepting or denying such requests. Additionally, individual 100 may also approve their home desktop computer. Individual 100 may, in one embodiment, set challenge requirements based on which device is accepting an authentication. For example, individual 100 may determine that their mobile phone is less secure than their home desktop computer, and may decide to set higher challenge requirements for their mobile phone to approve or deny a request than their desktop computer. Alternatively, if individual 100 is setting up their data record 140 at a third party institution, individual 100 may, after creating their data record in block 310, take the information comprised in their data record to a third party storage site 312.

In one embodiment, individual 100 may interact with third party storage site 312 in a digital environment. However, in an alternative embodiment, the third party storage system may require the individual 100 to physically come into a location in order to verify their identity. Once individual 100 has selected which third party storage system they want to use to store their information, the third party may then digitize (e.g. scan or otherwise upload into a storage medium) and store individual 100's information. Individual 100 may then predetermine settings as to what information in their data record 140 the third party is able to access in block 314. For example, while the third party storage may be housing the individual's 100 medical records, the individual 100 may not want the third party to be able to view said medical records. This may require the third party storage unit to set up partitions within the individual's data record such that information is or is not viewable to third party storage employees.

Individual 100 may, then, in block 316, predetermine challenge requirements for access to different portions of the data record 140 in a manner similar to that described at block 304. Additionally, individual 100 may then proceed to authenticate devices in block 318 that will be able to access third party storage. In one embodiment, the third party storage may authenticate devices on-site and may not allow for authentication through other mechanisms. However, in another embodiment, individual 100 may be able to authenticate any device by accessing the third party storage system's website or by another appropriate mechanism. Finally, regardless of whether individual 100 chooses to store their information locally or through a third party, individual 100, at a later date, in block 320 can approve addition of new information to their data record 140. For example, if, after creating the initial data record 140 including medical information 144, individual 100 may go to a doctor's office and have additionally tests run and, for example, receive an updated blood pressure result. Individual 100 may want to add this new blood pressure result to their data record 140. In block 320, individual 100 is able to approve addition of the new information to the data record, in one embodiment using an approved device.

### Authenticating and Responding to Data Requests

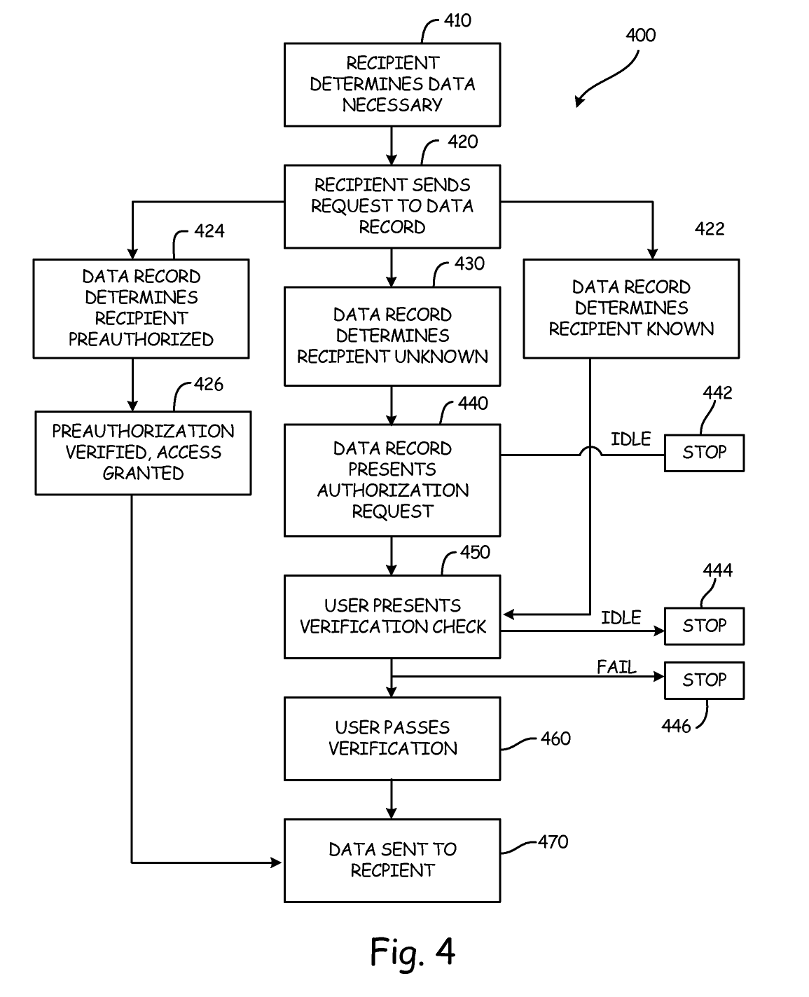

FIG. 4 shows a flow diagram of a method for authorizing and sending data to a data recipient in accordance with one embodiment of the present invention. This method may apply, for example to situations where a recipient is a known and preauthorized recipient, for example the bank 110 described previously. The method may also apply to a recipient that is known but not preauthorized, for example the doctor 120. Additionally, the method may further apply when the recipient is an unknown entity, for example a vendor 130 as described above. Requests are sent by an entity, e.g. bank 110, doctor 120, or vendor 130, to the storage provider of data record 140. In one embodiment, individual 100 may store data record 140 on a single device—for example a smart phone. Alternatively, data record 140 may be stored by a third party, for example a credit rating agency or other entity that typically collects and stores personal information of individuals. In another embodiment, the data record 140 may be stored by individual 100 in a cloud-storage space.

The method starts in block 410 by a recipient determining that data from the data record 140 of an individual 100 is necessary. In one embodiment, this may be the bank 110 determining that further information is needed in order to complete a mortgage application. Further, it could be a car dealership requesting information, for example the e-mail address of a recipient in order to send them deals for end-of-season specials on cars for sale at that dealership. Once the recipient determines what data is necessary in block 410, the recipient then sends a request to the storage provider of data record 140 in block 420 for the information requested. In one embodiment, the recipient could be requesting the entirety of data record 140 in block 420 or the recipient could be requesting a sub-portion of data record 140, for example all financial information, or an even smaller portion of data record 140, for example the e-mail address of the individual 100 associated with data record 140.

Once a prospective recipient has sent their request to the storage provider of data record 140 in block 420 the storage provider will then determine if the recipient is known, known and pre-authorized, or unknown to the data record 140, for example through a access log stored in the data record 140 or by using a settings file containing settings predetermined by individual 100. In the embodiment where the recipient is unknown, e.g. not listed in the data record 140 as a known requester of data, the method then proceeds through block 430. An unknown recipient requires further authorization, and may for example may require a higher security level than a known but not pre-authorized recipient. An authorization request is then presented to individual 100 requesting access be granted to the unknown requesting entity, in block 440. This authorization request presented in 440 may, in one embodiment, comprise sending a text message to individual 100 requesting authorization to send the data to the unknown recipient. The authorization request could also comprise requiring individual 100 to answer a series of challenge questions or present biometric data, for example a fingerprint, in order to authorize the sending of the data.

In one embodiment, if the authorization request sits idle for longer than a specified period of time, for example the specified period of time described above with respect to an average authentication time, the method terminates at block 442. In the event that individual 100 responds to the authentication request before the request times out, for example as shown in block 450 by responding to the specified format of authorization request, then the method continues. In block 450, individual 100 may respond by giving a fingerprint sample or otherwise satisfy the minimum authentication requirements. In one embodiment, if the device on which individual 100 is attempting to authenticate cannot perform the verification within the required period of time, the method again times out and terminates at block 444. Alternatively, if individual 100 does present information within the specified time but the information is incorrect, the method fails and ends at block 446. Additionally, depending on the sensitivity of the data requested, the period before the process times out may be different and, in one embodiment, can be set by either the requesting entity. In another embodiment, the individual 100 can also set the maximum time a request to access data record 140 can be pending prior to timing out. For example, a request for an individual's e-mail address may be allowed to pend for days before timing out. In another example, however, if the information requested is a social security number, the pending period may be much shorter, for example only minutes. Additionally, the time-out period may depend not only on the data requested, but may also depend on the entity requesting. For example data requests from a doctor may have a shorter pendency period than from a car dealer. Block 450 may also represent, in one example, a functional module that operates to prevent data in data record 140 from being revealed to an unauthorized entity. This functional module may operate to receive a question from a recipient, for example doctor 110 requesting whether or not individual 100 is HIV positive, and providing an answer based on a reference to the data record 140 without granting doctor 110 access to the data record 140. Or, in another embodiment, the doctor 110 may query as to what protective procedure is necessary to deal with the individual's blood. The functional module may transform that query into a question as to whether or not the individual has a communicable disease, and respond, based on an analysis of the medical records of individual 140, with a level of protection. For example, responding that gloves are required or that non-essential staff should be excluded from the treatment area.

Assuming that individual 100 presents correct verification information, the method proceeds to block 460. In one embodiment, for example, an indication is provided to individual 100 showing that individual 100 has passed verification and that information will be sent to the recipient. This may also include, in one embodiment, a final opportunity for individual 100 to deny information to be sent to the specific recipient. In another embodiment, individual 100 may also choose to agree to send some, but not all, of the requested information. For example, in the example where the car dealership requests a user's e-mail address, the car dealership may also be requesting individual 100's phone number. At this step, individual 100 may choose to agree to send their e-mail address but not their phone number. In block 470, once verification has been completed and any other limitations set on the information to be transferred, the data requested is sent to the recipient in block 470.

In the event that the request received by the storage provider of data record 100 is from a known recipient, the method moves from block 420 to block 422. Upon determining that the data recipient is known, an individual may bypass the initial authorization request and be presented instead with a verification because individual 100 has already interacted with this recipient in the past. The method then proceeds to block 450 and continues as described previously.

In an embodiment where the storage provider for data record 140 determines that a recipient is pre-authorized, for example that an individual 100 previously designated doctor 120 as pre-authorized to view all or a subset of medical records within data record 140. In another example, individual 100 may pre-designate their bank 110 as pre-authorized with respect to information related to their mortgage application, for example current credit score and current financial holdings. Once the storage provider of data record 140 determines that a particular recipient is pre-authorized in block 424 the pre-authorization status is verified using data record 140 and the storage provider grants access to the requested portion of data, sending the data to the recipient in block 470. In one embodiment, an indication may still be sent to an individual 100, for example through a notification on an application or through a text message and/or e-mail as designated by the individual 100, that data has been given to the pre-authorized recipient. This notification may also include, in one embodiment an invitation for individual 100 to change pre-authorization settings for the future.

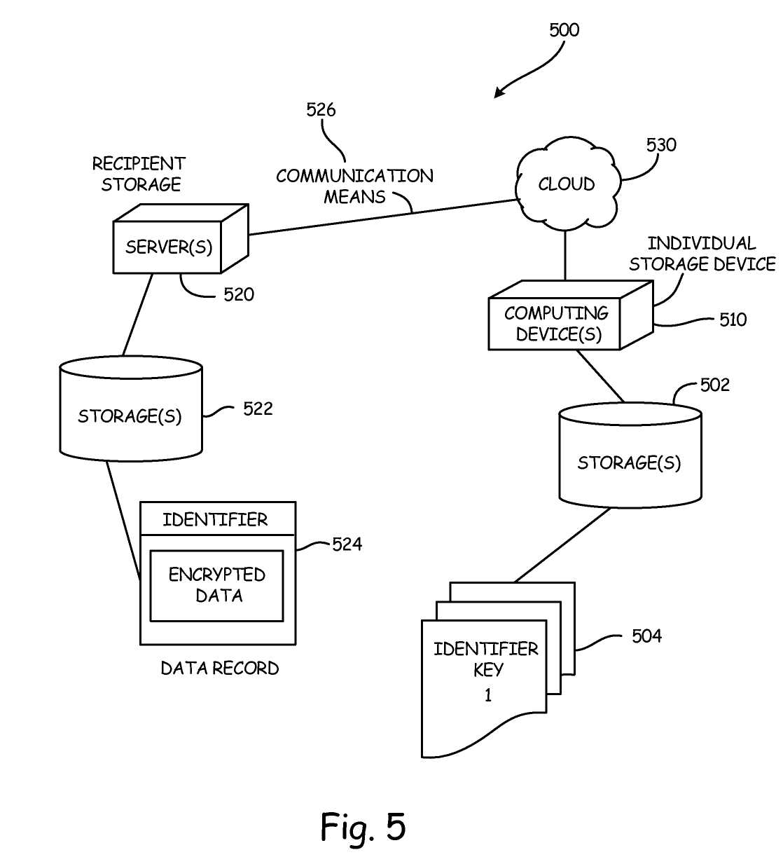

FIG. 5 shows an exemplary diagram of how information is transferred between individual 100 and a recipient. In one embodiment, as described in FIG. 5, the information is transmitted to a recipient through a cloud network 530. In one embodiment, the cloud network 530 may be a cloud storage system located on an Internet or other network. In another embodiment, the cloud network 530 may be located on an intranet or otherwise local network.

As described above, individual 100 is able to exert control in one embodiment over their information by permitting access or denying access to different recipients to different information in their data record 140. One control mechanism for securing information, as well as for securing access, is to store in the data record 140 a series of identifier keys 504, where each identifier key 504 corresponds to a packet of information in the data record 140.

In one embodiment, the recipient may already have access to encrypted data 524 of the data record 140 in the recipient's storage 522. The recipient's storage 522 may be located on the recipient's server 520. In such an embodiment, a user may have previously granted access to the recipient but only limited access, such that the recipient needs to further request a key to view the encrypted data. This may be the case in the example where individual 100 has granted access to a medical facility to store their medical records but requires that an individual doctor, or a specialist to receive access to that information by attaining an identifier key 504. However, the process works similarly if the information is stored by a third party of by the individual locally where the encrypted data is sent along with an identifier key 504.

The identifier key 504, in one embodiment, is necessary to decrypt encrypted data 524. In one embodiment, identifier key 504 is generated by the recipient and a copy is sent to the individual 100, who retains it on an authorized device. The recipient then destroys or secures their copy of the identifier key 504 such that it is inaccessible. When individual 100 grants access to the data record 140, the identifier key 504 is sent back to the data recipient so that they can access the data record 140. In one embodiment, a single identifier key 504 is tied to an entire data record 140. In another embodiment, multiple identifier keys 504 are tied to a data record 140 such that, for example, a first identifier key 504 is required to access medical records and a second identifier key is required to access credit card information.

In another embodiment, decrypting the encrypted data on a data record requires a combination of information from both the recipient storing the data and the individual 100. The recipient may encrypt the data and send the identifier key 504 to the individual 100 and may further encrypt the data and keep a second identifier key 504 in storage 522. Thus, if either identifier key 504 is intercepted during transit, the data record 140 is still inaccessible. In one embodiment, the two identifier keys 504 are combinable only once, creating a one-time access opportunity. In another embodiment, the two identifier keys are combinable each time the individual 100 grants access to the data record 140.

The identifier key 504 is, thus, not held in its entirety by the entity storing the data record 140 in any embodiment. In the event that the recipient is pre-authorized, as described in FIG. 4, the entity holding the data record 140 receives the key from the individual 100 without the individual 100 needing to take action to provide authorization.

One advantage of having encrypted data, such as data 524, is that the encryption process protects information in the data record 140 from being stolen or otherwise hacked into during the process of storing and transmitting it from the individual's data record to a recipient's storage. Additionally, data privacy regulations or internal policies may direct a recipient to store the information of the data record 140 separately from keys to unlock the data in order to ensure further privacy. In one embodiment, the individual has a computing device 510 with at least one portion of storage 502 where identifier keys 504 are kept. In one embodiment, identifier keys 504 correspond to different portions of encrypted data 524 within the data record 140. Additionally, the recipient storage may also contain at least one server 520, storage system 522 and may or may not already contain data 524 obtained previously from the data record 140. In one embodiment, upon realizing a need to access the data, the recipient sends a communication for example communication 526 through the cloud 530 to the individual computing device 510. Upon going through an authorization process, for example that as described earlier with respect to FIG. 4, the individual computing device will retrieve from storage 502 the identifier key 504 for the requested information from the recipient and pass that information back to the recipient's storage through the cloud and through the recipient's server such that the data 524 may be accessed by the particular recipient.

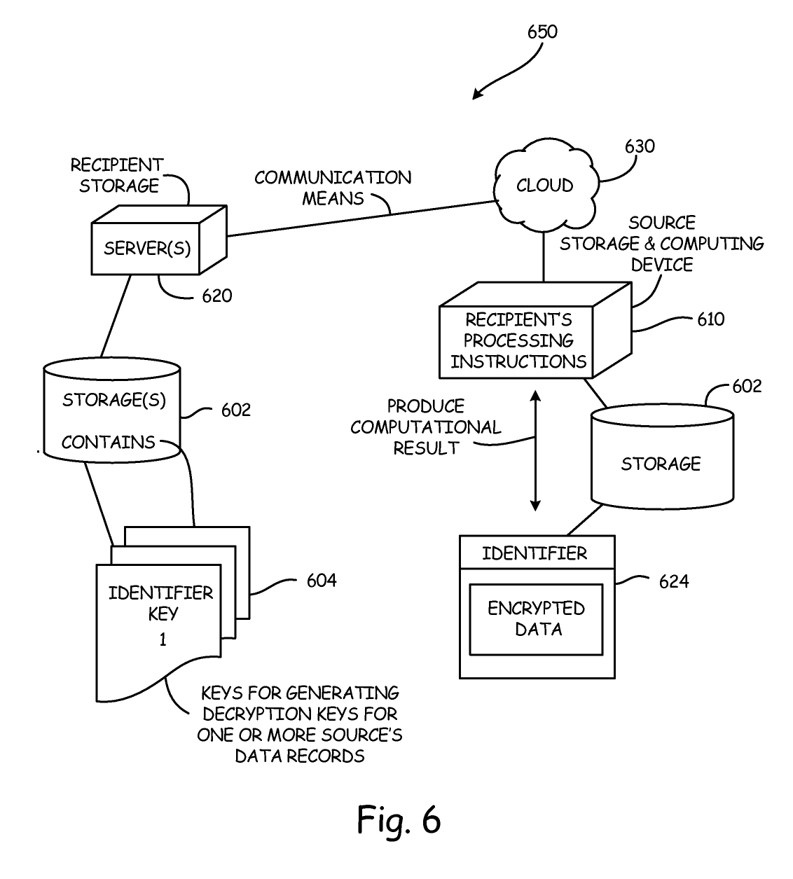

In another environment 550 as shown in FIG. 6, the recipient may have direct access to the identifier keys 504 and may use their own processing instructions in order to allow the recipient's website or application to access and decrypt data 524. In such a configuration as shown in environment 550, the recipient, instead of storing data 524, stores the identifier keys 504, and, as illustrated, may request the ability to access data 524. In such an embodiment, for example the pre-authorization process as described above with respect to FIG. 4, a notification may be sent to the individual 100 informing them that their data has been accessed and shared with the recipient in accordance with pre-authorization processes.

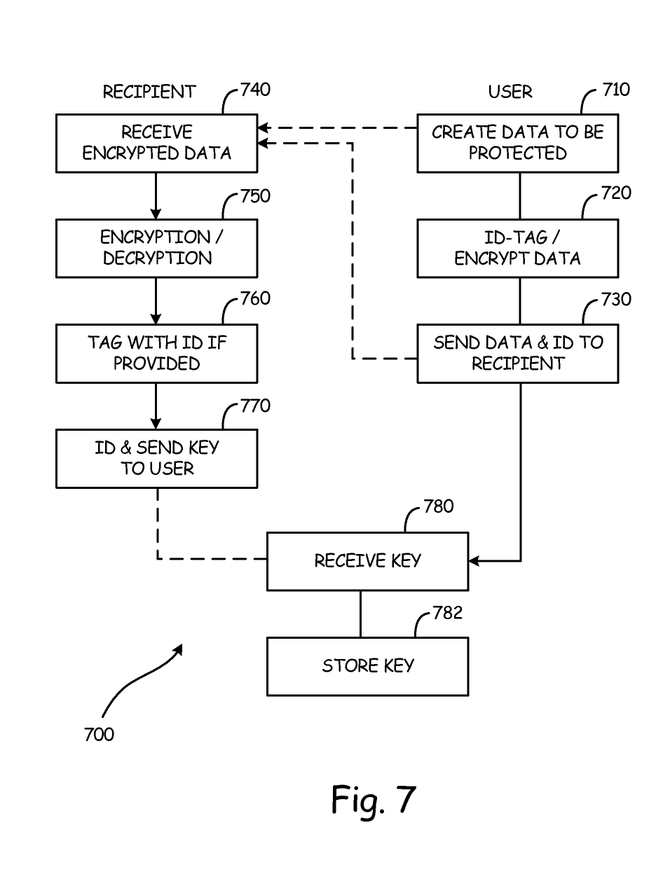

In one embodiment, as described with respect to FIG. 7, both a user and a recipient play a role in the process of generating and adding encrypted data to a data record 140. In one embodiment, as described with respect to FIG. 7, the process starts by a user generating, or, for example uploading, data to be protected in the data record 140. This occurs at block 710. In another embodiment, the data to be protected that is identified in block 710 may be provided from a recipient, for example updated medical records may be provided from a doctor 120.

Once the data has been identified in block 720, individual 100 may tag the data with different identifiers. These identifiers may allow for searching within a data record 140 or, in another embodiment, serve to subdivide data within the data record 140 for sharing. For example, a blood pressure result received from the doctor may be tagged as a medical record, a test result and/or a blood pressure record, such that it can be searched or shared as either a part of the full medical record, recent test results, or blood pressure data.

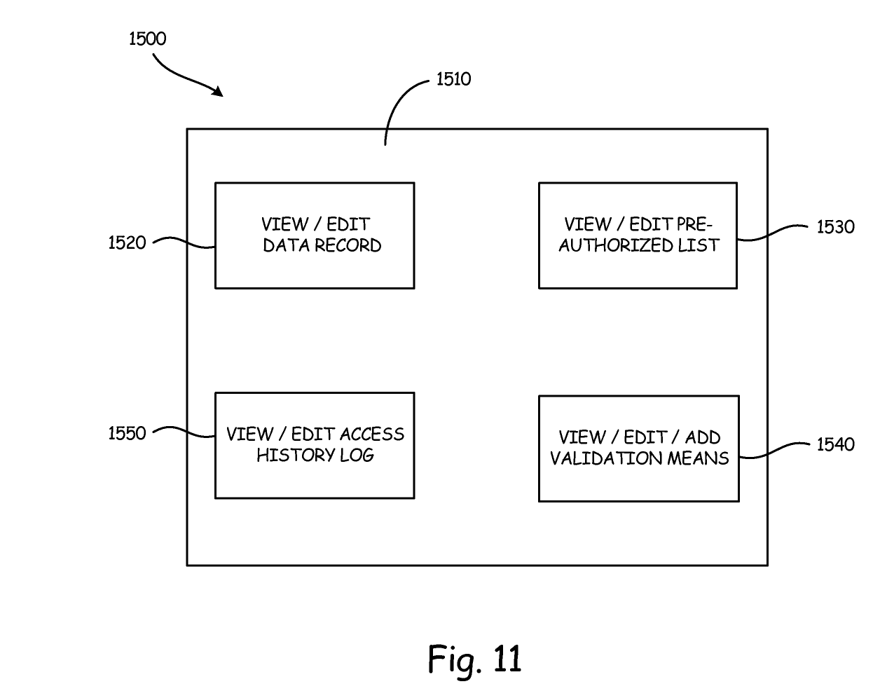

Once individual 100 has gathered data 524 and generated identifier tags, individual 100 then sends the data along with any identifier tags to the recipient, in block 730. As shown in FIG. 11, the recipient receives the data 524 from individual 100 in block 740. In the embodiment where the recipient does not store data 524, the recipient may need to go through a decryption process in block 1150 in order to initially read the data 524. However, in the embodiment where the recipient will store data 524 the recipient may create an internal encryption process in block 750. Some exemplary encryption methods may include, but are not limited to a Public Key Infrastructure (PM), a symmetric key encryption, an asymmetric key encryption, an RSA encryption, an Elliptical Curve (EC) encryption, an SHA-1 encryption, broadcast encryption, data encryption standard (DES), Advanced Encryption Standard (AES), International Data Encryption Algorithm (IDEA), Diffie-Hellman encryption, or a seed-based encryption. Alternatively, the encryption method may utilize, in one embodiment, hashing or signature functions such as Message Digest 5 (MD5) or Secure Hashing Algorithm (SHA) as well as watermarking validation methods. These and other encryption methods may be utilized by either or both of individual 100 and the recipient. In one embodiment, individual 100 and the recipient hold keys that utilize the same encryption method. In another embodiment, individual 100 and the recipient hold keys that utilize different encryption methods. In the event where the information is to be stored both by the source and by the recipient, both encryption and decryption may take place in block 750, where the recipient may decrypt any encryption set by individual 100 and further encrypt data 524 with their own internal encryption process. In block 760, the recipient may add additional identification tags to the information, for example a doctor 120 may tag a blood pressure result with a particular patient identification number. The doctor 120 may further tag the blood pressure information with a general checkup and/or a most recent blood pressure indication tag. In one embodiment, one piece of information may include multiple tags from both a user and a recipient. In a further embodiment, one piece of information may include multiple tags from both a user and plurality of recipients. For example, in the embodiment where individual 100's general physician further sends that blood pressure record to a specialist, the specialist may further tag the information indicating that it was sent from the general physician.

Once data 524 has been tagged, the recipient may then generates an access key, such as key 504 in one embodiment, to unlock data 524 and send the key 504 to individual 100 such that the recipient does not keep a copy of the key 504 post-transfer. The key 504 is received by individual 100 in block 780 and individual 100 may then store the key in block 782. In another embodiment, user may use the key to access data 524 once and then discard key 504. Alternatively, key 504 may be a temporary key, such that user can only access the information for a limited period of time. This may be useful, for example, in an embodiment where the user is accessing the information on a temporary terminal, such as a shared computer.

Individual 100 may store the key as indicated in block 182 within their data record 140 or may store the key within a separate partition of data record 140 or may further store the key 504 on a separate device, for example any and all authorized devices. The recipient then, in an embodiment where the recipient is not pre-authorized, may automatically destroy the key 504 such that it must go through the authorization process in order to access data 504 from individual 100 in accordance with one embodiment.

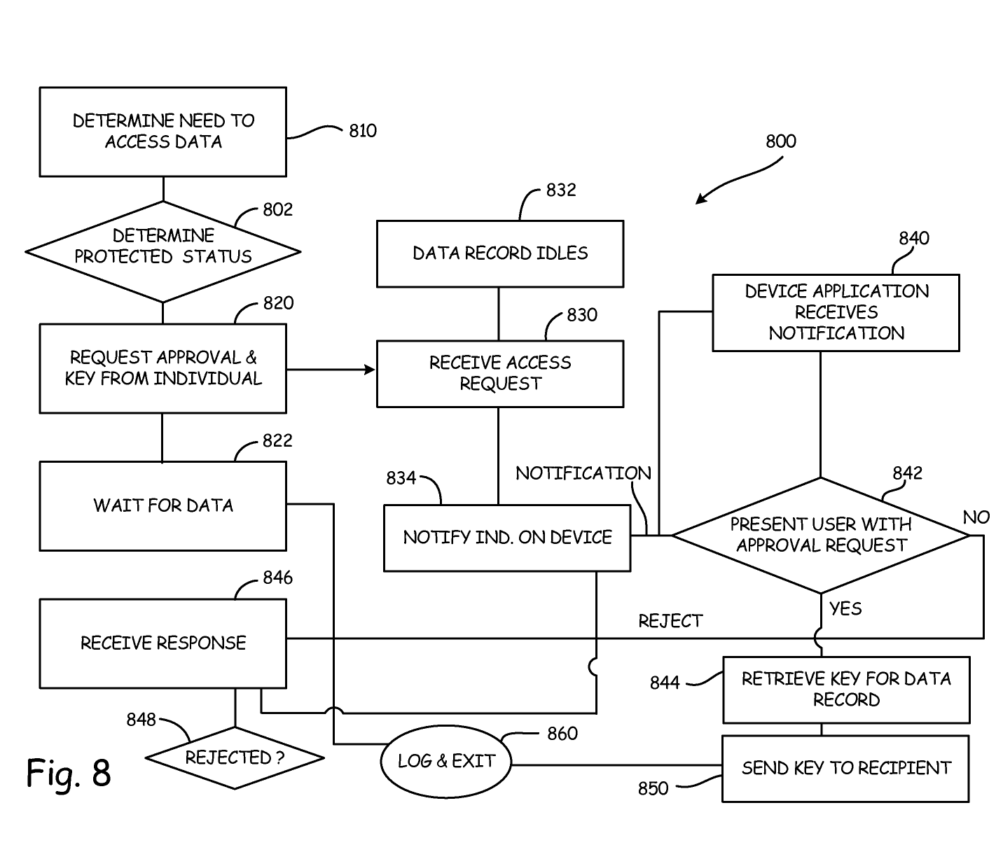

FIG. 8 presents a detailed flow chart of a recipient requesting and receiving a key 504 in order to unlock encrypted data 524 as described with respect to FIGS. 6 and 7. In one embodiment, the process 8200 starts at block 810 where a recipient determines a need to access data 524 from a data record 140. Once the specific data 524 needed is determined, the process moves to block 802 where the recipient determines whether or not the needed information is protected from the recipient's access. For example, in the embodiment where the recipient is preapproved and can access the source key without authorization from individual 100, the process ends here with the recipient receiving the key 504 and decrypting data 524 without needing to request the user's authorization.

In the event the data 524 is encrypted and recipient does not have the corresponding key 504, however, the process moves to block 820 where the recipient requests approval to access key 504 from individual 100. The recipient then waits for a response in block 822. In the event that the response is not received within a specific time frame, the method will automatically time out.

The data record 140, in one embodiment, is accessible through the storage provider in block 832 such that at any given time it can receive a request from a recipient for access to information in the data record 140. The storage provider of the data record 140, in one embodiment, receives the request for access in block 830 and determines whether or not the recipient is known or unknown in one embodiment. In one embodiment, if the data record determines that the recipient is pre-authorized, it may bypass the need to send a request to individual 100 and automatically respond to the request with key 504.

In block 834, the storage provider of the data record 140 presents a notification to the individual on one or all of the individual's authorized devices. For example, the storage provider may, during the daytime, present requests for authorization on individual 100's phone whereas on individual 100's phone is a notification whereas in the night time, the data record may present the information as a text message as set by individual 100. An individual's device receives the notification in block 840. In one embodiment, an individual installs an application on their device that is configured to receive and display the notification. However, in another embodiment, the data record sends a text message or an e-mail to a specific pre-authorized device in order to indicate that a request for access has been received.

In an embodiment where the device has installed an application that controls and facilitates access to data record 140, the device application presents individual 100 with an approval, request in block 842. In the event that individual 100 rejects the request for approval the response is received by the recipient in block 846. The response is received by the storage provider of the data record 140 in block 846. Upon determining that the data request was rejected in block 848, the storage provider of data record 140 may, in one embodiment, indicate to the recipient and to a user that the response was rejected. The rejection may then be logged within the data record 140, in block 860. This allows a user of the device to go back to whatever activity individual 100 was doing prior to the notification being sent to the authorized device.

In the event, however, that individual 100 approves the request presented in block 842, the data record then retrieves the key to access the specific data in block 844 and then the data record 140 sends the key to the recipient in block 850. Thus, any time that a recipient requests information it is either information from the data record it either receives a key in block 850 or is rejected in block 848. Regardless, the data record 140 will log the information being sent or rejected. Additionally, in one embodiment the application automatically closes after a request is approved or denied, returning a user to any activity the user was interacting with prior to a notification interrupting them.

### User Interface for Controlling Access Requests to Data Record

As has been described in several of the above-described embodiments, a user can approve and deny request to access their data record and otherwise adjust settings with respect to who can access their data record through a user interface. In one embodiment, this user interface may be presented to individual 100 through an application interface on an authorized device, for example a phone, a tablet or a desktop computer.

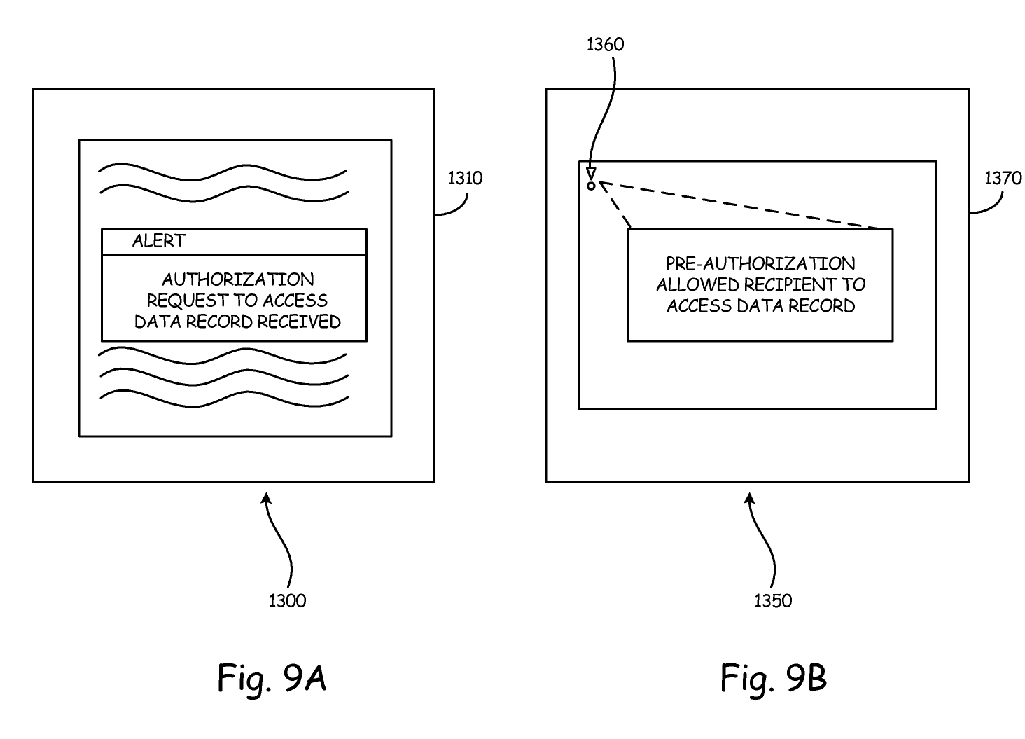

As shown in FIG. 9, an exemplary user interface is presented. In one embodiment, as shown in FIG. 9A, an alert is presented to a user that an authorization request has been received. In one embodiment, individual 100 may set preferences such that an alert will take over all or part of the screen such that it will grab individual 100's attention. In another embodiment, this may also include setting a portion of individual 100's screen to blink in order to indicate to a user who is not using their mobile phone or other authorized device that an authorization is pending. As shown in FIG. 9A, individual 100 was reading a news article and has now been presented with an authorization request to access their data record.

Additionally, in another embodiment as shown in FIG. 9B where a preauthorized recipient has requested and been granted access to the individual's data record, a notification may pop up in a portion of individual 100's screen, for example in an upper left hand portion where notifications of incoming messages, available e-mails, etc., are also presented to individual 100. In such an embodiment, upon clicking on the notification, a popup shows up on individual 100's screen showing that a preauthorization of an allowed recipient has been granted. In one embodiment, clicking on either the alert in FIG. 9A or the preauthorization indication in FIG. 9B will present individual 100 with an option to view an historical log or more information about the recipient, for example their preset settings with regard to that recipient's access.

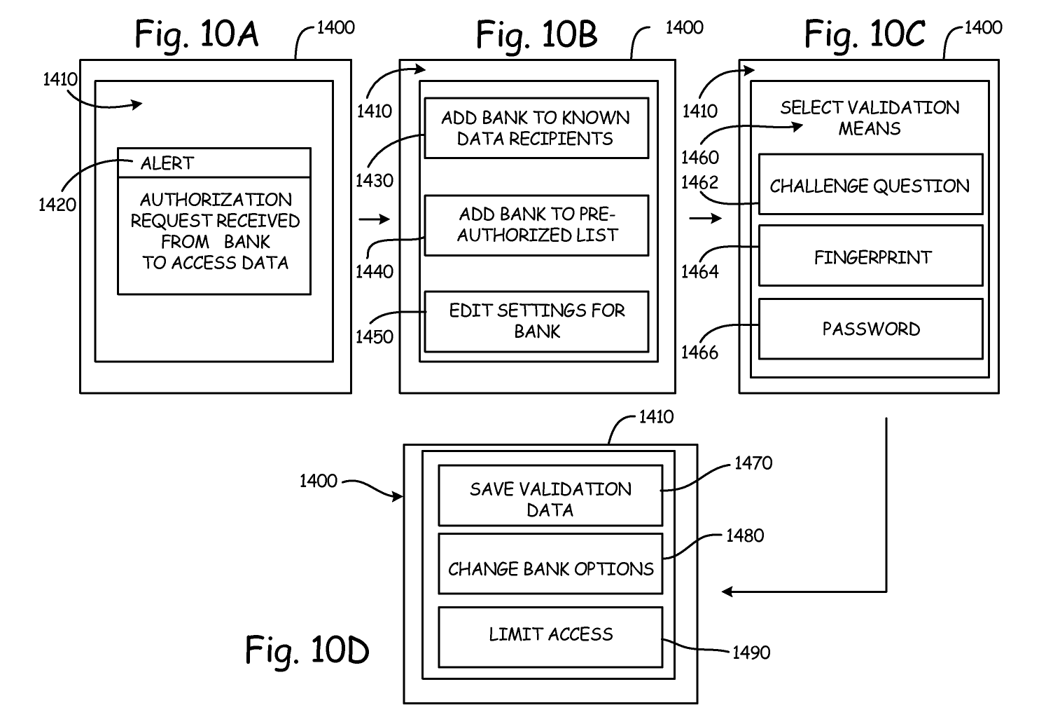

FIG. 10 illustrates a method allowing a user to change authorization settings with respect to a specific recipient. In one embodiment, the user is given an option to review and change authorization settings upon receiving an authorization alert from any recipient. As shown in FIG. 10A, individual 100 receives a notification on their device 1400. In one embodiment, individual 100 may view the alert in application environment 1410 on their device. In one embodiment, the alert 1420 shows that a request has been received from a specific recipient, in this case a bank 110.

Upon clicking on the authorization request, individual 100 moves to FIG. 10B to a page where they may choose to add or remove the bank to their known data recipients, add or remove the bank 110 to a preauthorized list, or edit a plurality of settings for the bank 1450. Upon selecting the edit settings for the bank 1450, individual 100 may proceed to FIG. 10C to a screen that may include a validation screen. In this embodiment, individual 100 may choose to select challenge questions 1462 as a primary validation means or select specific challenge questions for approving information to be sent to the bank. Individual 100 may also choose to only approve information to be sent to the bank upon a fingerprint in block 1464 or individual 100 may choose to require a specific password as shown in block 1466. In one embodiment, individual 100 may also set the specific password on this screen. Upon changing the validation data in FIG. 10C, individual 100 then moves to FIG. 10D which presents the same user interface screen 1410 which gives individual 100 the option to save their validation data 1470, change other options in 1480 for example individual 100 may also choose to change information that the bank is able to access. Additionally, individual 100 can limit access options in block 1490.

In one embodiment, for example the embodiment shown in FIG. 10, a method is provided for electronically storing and providing access to data in the data record 140. The method may be implemented on a computing device with a processor. The method comprises receiving an initial data item from individual 100. The data item may be a single data file, for example a credit card number, or a plurality of data files, for example a medical history. The method further involves storing the data pertaining to individual 100 such that the data file is marked or otherwise keyed to individual 100 such that individual 100 is the only entity that can control access to the stored data in the data record 140. The method also involves receiving a request for a portion of the data record 140, for example the credit card information file. Upon receiving a request for access to the data record 140, an alert is sent by the entity storing the data record 140 to individual 100. In one embodiment, the requestor of data will not receive access to the data in the data record 140 unless the individual 100 responds to the alert by indicating that access is granted. In one embodiment, the response must be received within a pre-determined period of time. In another embodiment, the individual 100 may respond to the alert with specific instructions for access, for example access for a set period of time, or access only to a sub-portion of the requested portion of the data record 140, for example only to the individual 100's e-mail address but not their phone number or mailing address. Upon receiving the response from individual 100, the entity holding data record 140 acts accordingly. In one embodiment, the entity holding data record 140 cannot grant access to the data in the data record 140 until receiving the key 504 to the portion of the data record from individual 100.

In one embodiment, the individual 100 may provide one of a plurality different responses—an affirmative grant of permission to access the data record 140, a partial grant of permission to access the data record 140, or a denial of permission to access the data record 140. In the embodiment where individual 100 holds the key 504 to the data record 140, grant of permission to access the data record 140 may comprise giving temporary access to the key 504 to the holder of the data record 140. Individual 100 may also respond, in another embodiment, by sending a derivative of key 504 that allows the holder of the data record 140 to grant one-time access to the data record 140. After receiving the key 504 and transferring the requested data to the recipient, the entity holding the data record 140 may then destroy their copy of the key 504. In another embodiment, the entity holding the data record 140 may generate a new key 504 and send a copy to the individual 100, and then destroy their copy such that the individual 100 retains the only copy of the key 504 to the data record 140.

FIGS. 10B and 10D show alternative user interfaces that allow an individual 100, in one embodiment, to alter access parameters for entities to data record 140. Additionally, in one embodiment as shown in FIG. 10B, individual 100 may edit settings for access for a specific entity, for example as shown in box 1450. For example, individual 100 may restrict portions of the data record 140 from being accessible to an entity, or set different validation means required for granting access.

FIG. 10C shows a plurality of exemplary validation means that may be used to allow or deny permission to access data in the data record 140. In one embodiment, individual 100 may be required to answer a challenge question correctly before access to the data record 140 can be granted. In another embodiment, the validation means may be based on biometric information, for example fingerprint match, iris match, or other appropriate biometric validation means. In a further embodiment, the validation means may be the entry of a password or may be based on any NIST 800-76-2 approved authentication mechanism, or other appropriate validation mechanism.

FIG. 11 shows an exemplary home screen of an application environment 1500 where home screen 1510 includes a plurality of options for a user to interact with their data record including a view data record 1520 option, a view or edit preauthorized list 1530 option, a view or edit validation means 1540 option, or a view access history log 1550 option.

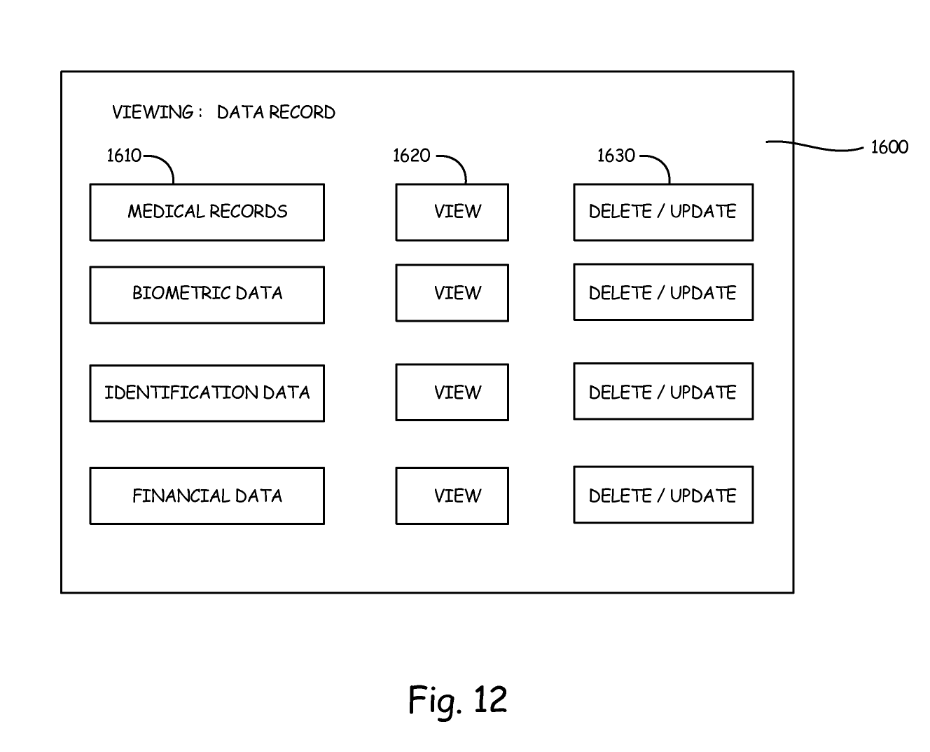

FIG. 12 shows an exemplary interface 1600 that may be presented to a user upon clicking the view data record 1520 option as shown in FIG. 11. In one embodiment, individual 100 is presented with a column 1610 related to different portions of their data record 140 and an option to view 1620, delete or update 1630 of the sub-portion of the data record 140. In one embodiment, upon clicking on medical records in FIG. 12, individual 100 may be taken to another screen that further shows additional sub-portions of medical records within the data record 140, for example, vaccine records as opposed to test results. Individual 100 may view specifics with regard to each portion of their data record 140 through any of the view 1620 options. Individual 100 may also choose to delete or update the accessibility of each of the medical records by clicking on any of the delete or update access options 1630. In one embodiment, there is no limit to the number of portions and sub-portions of the data record 140 that a user can have.

In one embodiment, individual 100 may use the interface to delete data that an entity can access, or delete data from the data record 140 altogether (as shown in further detail in FIG. 12). Individual 100 may also set parameters for deleting data files from the data record 140, for example individual 100 may set parameters such that when an updated version of data (for example a current weight of individual 100) is inserted into the data record 140, that any older versions of that data are deleted. Alternatively, individual 100 may set parameters such that certain data files in the data record 140 are deleted after a pre-determined period of time or a pre-determined period of time of none-access. For example, pictures may be deleted after being in the data record 140 for one year, in one embodiment. In another embodiment, individual 100 could set data to be deleted at a certain date or after access by an entity. In one embodiment, the parameters surrounding deletion of data from the data record 140 may be pre-determined by applicable state or federal law applying to the nature of the data based at least in part on where the data in the data record 140 was created and/or accessed and/or stored.

Individual 100 may also move portions of data record 140, or the entirety of data record 140 between storage media. For example, individual 100 may move data from a third party storage facility to a local storage device in one embodiment, for example a mobile device or local computer. In another embodiment, individual 100 may allow permanent storage of data from the data record 140 by the recipient. As shown in FIG. 12, in one embodiment, individual 100 may move portions of data record 140 between a local data storage medium, a remote data storage medium, a recipient-controlled data storage unit, or a third party data storage medium.

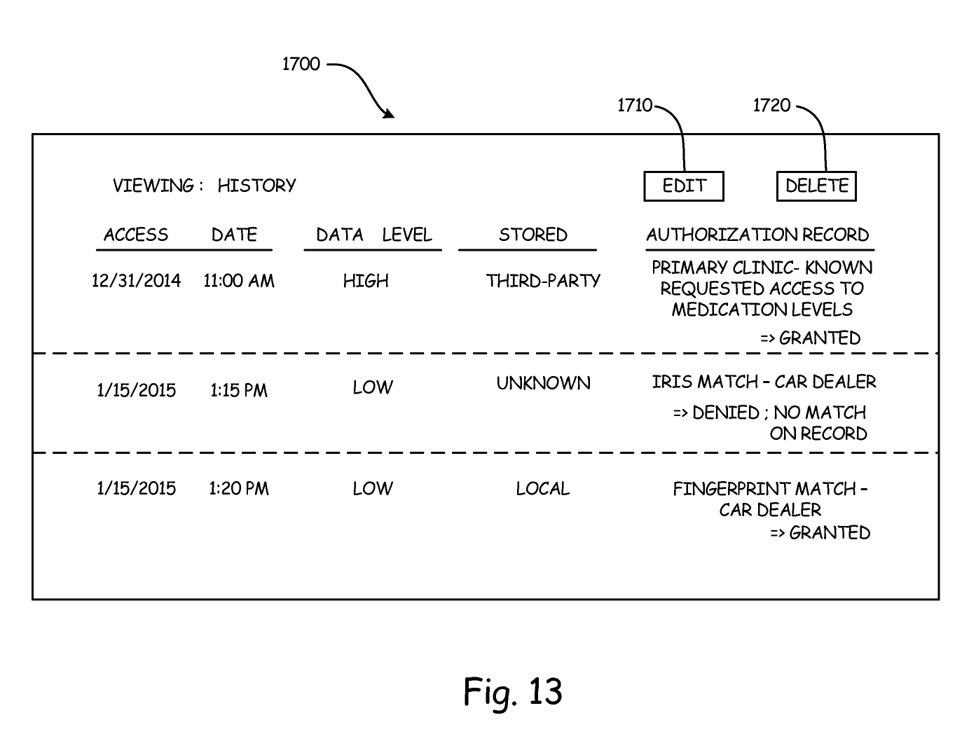

FIG. 13 shows a history screen 1700 that is presented to a user upon clicking on the view edit history log 1550 option in FIG. 11. In one embodiment, the history screen 1700 includes an access date and time column, a data level column, a storage indication column, and a detailed authorization record column. In one embodiment, the access date includes both a date, a month, a year and a time that any portion of the data record was accessed whether or not the recipient was preauthorized, known or unknown. In one embodiment, the specific data accessed is given a data level for example high or low. In one embodiment, individual 100 may set the data security level to be high, medium or low or any portion in between low and high on a spectrum for example based on how important that data is. In one embodiment, however, data may have a preset security level, for example a social security number of individual 100 may be indicated with a high security level as theft that information could result in significant consequences for a user.

In one embodiment, when information is classified as a high security portion of information individual 100 may have to use multiple forms of authentication to access that information, for example both a fingerprint and a correct answer to one or more challenge questions. In one embodiment, the screen 1700 also presents a storage indication showing where the information is stored. For example, the information may be stored on the third party or local storage. Additionally, as shown in the second entry of the history log shown in screen 1700, a storage indication may be unknown because that information does not exist. For example, individual 100 of screen 1700 may not have entered an iris match at any specific time which might be both why the request was denied and why the storage is unknown. Additionally, the detailed authorization record provides further information about who accessed the information and whether or not the access was granted. For example, the first entry in the history log shows that a medical clinic accessed the information and was approved for their request for medication levels.

Although the present invention has been described with reference to preferred embodiments, workers skilled in the art will recognize that changes may be made in form and detail without departing from the spirit and scope of the invention.

What is claimed is:

1. A method of controlling access to stored data, the method comprising:
receiving a request from a recipient to access to the stored data, wherein the stored data is associated with an individual;
notifying the individual of the request to access the stored data;
requesting authorization for the recipient to access the stored data;
receiving a response from the individual regarding authorization to access the stored data and, upon a determination that authorization is granted, allowing the recipient access to the stored data; and
wherein the method is implemented on a computing device with a processor.

2. The method of claim 1, wherein requesting authorization comprises generating an alert to the user that access has been requested.

3. The method of claim 2, and further comprising the steps of:
logging the request to access the stored data;
storing information about the recipient requesting access;
documenting whether access was granted; and
documenting a scope of access granted for each attempt.

4. The method of claim 2, and further comprising:
displaying a security interface wherein the individual manages authorization requests and data access.

5. The method of claim 2, wherein the stored data may be housed in at least one of the following:
a local data storage;
a remote data storage;
a recipient-hosted data storage hosted; or
a third party data storage.

6. The method of claim 1, wherein requesting access comprises providing an inquiry and wherein the method further comprises:
comparing the inquiry against the data record using at least one method of data manipulation;
returning an answer to the inquiry to the recipient based on the data manipulation; and
wherein the process of comparing is conducted such that the data record is segregated from the recipient.

7. A method of storing and providing access to a data record, the method comprising:
receiving a request for access to the data record;
determining a status of an entity generating the request;
generating an authorization request;
presenting the authorization request to a user associated with the data record;
upon receiving authorization, granting the requested access; and
wherein the method of approving access to a data record is implemented on a computing device with a processor.

8. The method of claim 7, wherein presenting the authorization request comprises at least one of the following:
generating and sending a text message to the user associated with the data record;
generating and sending an electronic message to the user associated with the data record; or
presenting a notification to the user associated with the data record.

9. The method of claim 7 and further comprising:
storing an indication of the request for access to the data record, wherein the indication comprises:
an entity identifier, identifying the entity generating the request;
an indication of approval status of the authorization request, wherein the indication of approval status comprises an indication of whether the access was granted.

10. The method of claim 7 and further comprising:
terminating the request without granting access to the data record upon receiving a termination indicator.

11. The method of claim 10, wherein the termination indicator comprises an indication that a maximum time has passed without receiving authorization.

12. The method of claim 10, wherein the termination indicator comprises an indication that the user failed to present proper authorization.

13. A computing device, comprising:
a memory component comprising:
a data record comprising at least one data file;
an authorization matrix, wherein the authorization matrix comprises a plurality of entities, each assigned a security level;
an access log comprising an indication of attempted access; and
wherein an attempt to access the data file by one of the plurality of entities is processed by the authorization matrix such that a notification is sent to a user associated with the data record indicating the security level of the entity;
a user interface configured to allow the user to interact with the data record stored on the memory component; and
a processing unit configured to facilitate access of the memory component through the user interface.

14. The computing device of claim 13, wherein the data record further comprises a file hierarchy, and wherein the data file is stored within the file hierarchy.

15. The computing device of claim 13, wherein the security level is assigned by the user associated with the data record.

16. The computing device of claim 13, wherein the indication of attempted access comprises, a data file identifier indicating the data file associated with the attempted access, an entity identifier that comprises an identifier of the entity requesting access, a security level indication associated with the entity, and an indication of approved/denied status of the attempted access.

17. The computing device of claim 13, wherein the data file comprises data generated by the user.

18. The computing device of claim 13, wherein the data file comprises data generated by one of the plurality of entities in the authorization matrix.

19. The computing device of claim 13, wherein the data record is stored on a computing device controlled by the user.

20. The computing device of claim 13, wherein the data record is stored on a computing device controlled by one of the plurality of entities in the authorization matrix.
